(19) United States
(12) Patent Application Publication
(10) Pub. No.: US 2016/0048205 A1
(43) Pub. Date: Feb. 18, 2016

(54) Sensor Proximity Glove for Control of Electronic Devices

(71) Applicant: Iron Will Innovations Canada Inc., Lloydminster (CA)

(72) Inventors: Brent Baier, Lloydminster (CA); Curtis Figley, Edmonton (CA); Darin Hunt, Edmonton (CA); Andrei Chickak, Edmonton (CA)

(21) Appl. No.: 14/822,191

(22) Filed: Aug. 10, 2015

Related U.S. Application Data
(60) Provisional application No. 62/036,868, filed on Aug. 13, 2014.

(51) Int. Cl. G06F 3/01

(52) U.S. Cl. CPC G06F 3/014

(57) ABSTRACT

The present invention relates to a device for interacting with computerized devices. In particular, the device comprises a wearable glove having a plurality of proximity sensors that can send information to, and receive information from, a computing device for the purpose of executing tasks thereon.

### RELATED APPLICATIONS

The present application claims priority to, and incorporates by reference, U.S. Provisional Patent Application No. 62/036,868 filed on Aug. 13, 2014. U.S. Pat. No. 8,704,758 and No. 7,498,956 are incorporated herein by reference thereto.

### BACKGROUND OF THE INVENTION

1. Field

The present invention relates to a physical device for interacting with computerized devices. In particular, the device comprises a wearable glove having a plurality of sensors that detect proximity and can be used in connection with a computing device for the purpose of executing tasks based thereon.

2. Background

There are a number of devices available that allow a human to interface with computing and electronic devices. These include keyboards, the mouse, keypads, game pads, joysticks, and the like. Each of these devices translates the acts and actions of a human through modality particular to the interface device for the purpose of controlling a computing device. In some cases, the translation is quite complex and takes a great deal of time, coordination, and effort to master, such as is the case of a keyboard. Additionally, some individuals with physical and mental limitations may never be able to master such devices. Other devices provide a method of communication that is easy to learn, but very limited in terms of complexity—such as a computer mouse that typically has only two buttons with which to interface with a computer.

At the same time, the functionality of computer programs and associated tools has increased dramatically requiring higher levels of control and input, thereby placing greater demands than ever on the ability of the user to communicate quickly and at a high level with the computing device. This is especially true in the case of gaming applications, sports related applications, and applications used by users performing critical functions like law enforcement or medical treatment, as well as many other applications.

In each instance, prior art interfaces suffer from inherent drawbacks by limiting and restricting the flow of information between the user and the computer, as well as requiring the user to master a means of communication that is unnatural, inefficient, or overly complex.

Further, electronic devices have become increasingly mobile, with devices such as smartphones able to perform a wide variety of functions useful in everyday life. Mobile devices are now being used in numerous sports and exercise settings, allowing users to listen to music, capture action videos with body-mounted cameras, or view crucial information with head mounted displays. Professionals in law enforcement settings are seeing increasing adoption of mobile technologies to help them fulfill crucial tasks, such as capturing video in sensitive law enforcement situations. Military personnel are seeing greater use of body worn technologies such as head mounted displays and communication devices.

Many of the applications of these mobile/body worn devices require interaction from the user, ranging from simple (START/STOP) to complex (menu navigation, text or numeric input). Current methods of input, such as touch screens or physical buttons, require the user to divert their focus from their current task to the device, typically requiring them to stop, take the device out of their pocket, look down, and visually locate then touch the appropriate button. This results in users being distracted from their current task, and in the case of law enforcement, military, or sports users, this could result in loss of life in extreme cases. At a minimum, the interruption of focus to interact with a device is an inconvenience that often reduces the users' efficiency and can interrupt and lessen the enjoyment of their experiences.

In particular, U.S. Pat. No. 8,704,758 and No. 7,498,956 disclose novel and creative solutions to problems in the art; however, these references teach an application that requires direct electrical contact to measure resistance between sensors to send signals from the wearable device to the computing device. While effective, this approach limits the range of possible communication and thereby reducing the correlation between the motion creating the signal and what is being controlled on the computing device.

Thus a need exists for an improved interface with computing devices that substantially eliminates the problems of the prior art.

### DETAILED DESCRIPTION OF THE INVENTION

The purpose of the present invention, in its various forms, is to allow users to easily and naturally interact with technology and electronics (without having to divert their focus from a task to the technology and electronics).

The invention comprises a glove that detects the proximity of sensors/tags in the glove relative to various areas on the hand. It consists of a glove with tags/sensors on it, and a device located on the hand (or nearby) that detects the proximity of the tags or triggers the sensors based on such proximity. This device could be located on the palm and/or thumb, but can be placed in other locations. The device can be integrated into the glove. When the tags/sensors become active, a signal is sent to the device or detected by the device. The device then communicates with an electronic device operating a program where the signals are used to control one or more aspects of the program or other technological functionality operating on the electrical device. Electrical devices can include a computing device such as a server, desktop computer, network computer, laptop, mobile computer, a controller such as device controlling a piece of equipment, and the like.

Implementation of the device in any manner could also include a wireless transmission method for communication between the glove and the electronic devices to which it interfaces and operatively communicates therewith. The device could also be configured to detect chording instances where multiple tag/sensor detections produce a unique output (i.e. two fingers bent toward the palm simultaneously could produce a unique output). The device may also use inductive coupling communication between the device and the tags/sensors to create a system that can be completely enclosed with an airtight, waterproof, fireproof enclosure, reducing the likelihood of foreign contaminants.

In one embodiment of the present of the invention, the tags/sensors comprise uses RFID (Radio Frequency Identification) tags embedded in the fingers of the gloves or other areas of the glove. In this case the device comprises a specially shaped antenna embedded in the palm or thumb that creates a radio field that excites the RFID tags when they are in close proximity to the antenna—the RFID tags do not need to contact each other to create a signal they only need to come within a prescribed proximity defined by the type of antenna/RFID tags selected to initiate a signal that would then be communicated to the electronic device executing a program. When the RFID tags are excited, the antenna receives information from the RFID tag, which the system then interprets as a unique signal because each RFID tag is individually identifiable, which can then be assigned to a particular function or task performed by a program interfaced with the device in the glove. When the finger/RFID tag is not close enough to the antenna, no signal is generated. Due to the unique shape of the antenna in the palm and/or thumb, the radio field can be tuned to be accurate in sensing of the proximity of the RFID tags. For example, the antenna can be tuned to sense when the tags are within 1.5″ of the palm or thumb. Furthermore, the range and the shape of the antenna sensing field is dynamically configurable, which can be used to adjust the sensitivity of the sensors and to further enhance the scope and complexity of the command capabilities of the wearable device. For example, if the electronic device is being used for a highly sensitive task the range can be correspondingly adjusted to allow the user's hand to have an even greater level of control.

Additionally the tags can be placed in any area of the glove that would allow for similar effect and results.

By sensing proximity using radio signals in this manner, the device can still sense the proximity of RFID tags through layers of clothing or other materials which would not interfere with the transmission of the signals.

In another embodiment of the present invention, the invention could be used as an RFID reader. The glove configured with at least an RFID antenna can be used as an RFID reader of standard RFID tags not mounted on the glove. The user would pass their palm over a box/article of some type (for example clothing/etc.) which contains an RFID tag bearing information about the box/article, and the tag could be read and information sent to the appropriate device or application. This would allow the user to use the glove as a wearable RFID reader for any application that uses RFID tags, as the embedded antenna could be configured to detect RFID tags in configurations and settings such as inventory tracking This would free up the user from having to carry around a separate RFID reader device.

Additionally, the device may use inductive coupling of the antenna to an electronics pod, thereby resulting in a sealed system resistant to dirt, water and other foreign substances. By configuring the device in this manner, the glove can also become a consumable product, as it would contain no active electronics.

Another embodiment of the present invention would use Hall Effect sensors located on each finger, with wires running from each sensor to the device/electronics pod. A magnetic field generator would then be located on the palm and/or thumb. When the Hall Effect sensor reaches proximity to the magnetic field, its voltage changes in correspondence thereto. This voltage change is detected by the system and interpreted as a unique signal. This would allow, for example, communication of distance related information that can then be used by the program of the electronic device. The voltage from the sensor would vary as the distance between the sensor and the field generator varies. This information can then be correlated to functionality that requires a continuous rather than discrete (on/off) control. Of course, the locations of the sensors, generator, and wires can and will vary

Additionally, the invention can be comprised of more than one wearable device. For example, the invention can be comprised of two gloves and the signals can be produced based on an interaction between tags/sensors in the two gloves and/or fingers of the hands, wherein the action is correlated or simulated to the movement between the gloves. The invention can include wearable devices on other parts of the body, such as shirts, pants, hats, and the like. Tags/sensors could be located on a variety of places, including other devices, objects or articles of clothing. When the glove(s) are in proximity to the various tags/sensors unique actions can be triggered.

The glove can detect when the user's fingers are close enough to the palm to indicate a grip position and could be used to detect whether or not a user is gripping a piece of equipment. Once the user releases their grip, whether intentionally or accidentally, a signal can be sent to the equipment to turn off. The glove can also be configured to be liner glove to fit under existing industrial safety gloves, making the technology easier to adopt.

Furthermore, a flexible strain or bend sensor could be used to detect not only proximity but the shape of the hand or fingers, which can then be conveyed to the electronic device to provide more resolution signal. For example, moving the fist could convey a stop signal to a program or to a piece of equipment controlled by the program. Bending or curling one or more fingers could be a unique signal, perhaps used for counting or for menu navigation functions such as scrolling. Other arrangements are possible. Such sensors can be woven or embedded into fabric, or applied to the inner or outer surface of a wearable item.

The advantage of the present invention is that it allows users to interact with electronics and applications in mobile or focus intensive situations without the need to divert their attention from their current task.

The present invention substantially overcomes the problems of the prior art by providing an interface device that seamlessly, intuitively, and efficiently communicates commands to a computing device. The interface device can be used to correlate natural hand movements with corresponding functions in a computer program, such as gripping, lifting, tapping, and the like. Additionally, the interface device can be used to simulate other natural acts like playing an instrument, typing, using sign language, and the like. The device allows the user to interface with a computer without diverting their attention from other tasks, which in some cases can prevent dangerous conditions from occurring. Further, the sensors used are proximity sensors that do not require a direct physical connection or electrical connection to send a signal, and the sensors can provide a continuous proximity signal instead of being limited to a discrete value.

These and other advantages will be apparent to those of ordinary skill in the art.

While the various embodiments of the invention have been described, the invention is not so limited. Also, the method and apparatus of the present invention is not necessarily limited to any particular field, but can be applied to any field where an interface between a user and a computing device is applicable.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A wearable device for use as an interface for sending signals to an electronic device, comprising:
a wearable article;
a plurality of sensors incorporated into the wearable article; and
a device for sensing signals from the sensors and adapted for sending signal information to an electronic device for use in program control.

2. The invention of claim 1 wherein the sensors are proximity sensors.

3. The invention of claim 1 wherein the sensors are RFID sensors.

4. The invention of claim 3 wherein the characteristics of the device that senses the RFID field may be adjusted to change the shape and strength of the RFID sensing field.

5. The invention of claim 1 wherein the sensor is a bend sensor.

6. The invention of claim 1 wherein the sensor is a strain sensor.

7. The invention of claim 1 wherein the sensors are hall effect sensors.

8. The invention of claim 7 wherein the signal from the sensor is relative to the distance between the sensor and the device.

9. The invention of claim 1 wherein the wearable article is a glove.

10. The invention of claim 1 further comprising a second a wearable article with a plurality of sensors incorporated into the wearable article wherein the signal information is comprised of signals from both gloves.

11. The invention of claim 1 wherein the device utilizes inductive coupling to create a sealed environment.

12. A wearable device RFID reader, comprising:
a wearable article with a device for sensing RFID signals from the surrounding environment when the article is passed in relatively close proximity to RFID sensors located in the environment.

13. The invention of claim 12 wherein the wearable article is a glove.

14. A electronic signaling system, comprising:
a wearable article comprising a glove;
a plurality of proximity sensors incorporated into the glove;
a device for sensing the relative position of the sensors;
a programmable electronic device for receiving signal information from the device and using the information for controlling a program executing the device.
